(19) United States
(12) Patent Application Publication
(10) Pub. No.: US 2012/0110037 A1
(43) Pub. Date: May 3, 2012

(54) Methods and Apparatus for a Read, Merge and Write Register File

(75) Inventor: Kenneth Alan Dockser, Cary, NC (US)

(73) Assignee: QUALCOMM Incorporated, San Diego, CA (US)

(21) Appl. No.: 12/916,931

(22) Filed: Nov. 1, 2010

(51) Int. Cl. G06F 17/30

(52) U.S. Cl. 707/822; 707/E17.005; 707/E17.01

(57) ABSTRACT

Processor systems utilize register files coupled to a processor's memory system and execution units and process various data types that are mixed with single instruction multiple data (SIMD) instructions to improve processor performance. To reduce processor pipeline stalls waiting for dependency operands to be generated and written back to the register file, a method of read, merge, and write is used. An operand partitioned into two or more portions is read from a register file. A value from an execution unit is merged in place of one portion of the two or more portions of the operand to create a merged operand. The merged operand is operated on to generate a merged operand result, and the value is written to the register file.

### FIELD OF THE INVENTION

The present invention relates generally to processors, and more specifically to combining processor operations of dispatched instructions having different data path requirements.

### BACKGROUND OF THE INVENTION

Many portable products, such as cell phones, laptop computers, personal digital assistants (PDAs) or the like, require the use of a processor executing a program supporting communication and multimedia applications. The control system for such products includes one or more processors, each with storage for instructions, input operands, and results of execution. For example, the instructions, input operands, and results of execution for a processor may be stored in a hierarchical memory subsystem consisting of a general purpose register file and multi-level instruction caches, data caches, and a system memory.

In order to provide high performance execution of programs, a processor typically executes instructions in a pipeline optimized for a target application and for a process technology used to manufacture the processor. The executed instructions may specify particular operands from a plurality of sources, for example from the register file, cache(s) or system memory. Retrieval of operands from some of these sources (for example, but not limited to, system memory) may take multiple execution cycles. Other instructions may specify a source operand that is a result of executing a previous instruction. Obtaining an instruction specified operand from a source which has a multiple execution cycle retrieval time or from a previous execution may result in stalling the processor for one or more cycles until the operand is ready.

### SUMMARY OF THE DISCLOSURE

Among its several aspects, the present invention recognizes a need to address processing of various data types that are mixed with single instruction multiple data (SIMD) instructions to improve processor performance. To such ends, an embodiment of the invention applies a method of read, merge, and write. An operand partitioned into two or more portions is read from a register file. A value from an execution unit is merged in place of one portion of the two or more portions of the operand to create a merged operand. The merged operand is operated on to generate a merged operand result, and the value is written to the register file.

Another embodiment of the invention addresses an apparatus having a register file, first execution logic, multiplexing logic, second execution logic, and write back logic. The register file has a port for reading an operand partitioned into two or more portions. The first execution logic is configured to generate a value in a first cycle. The multiplexing logic is configured to merge the value in place of at least one portion of the two or more portions of the operand to create a merged operand. The second execution logic is configured to perform an operation on the merged operand to generate a merged operand result in a second cycle. The write back logic is configured to write the value to the register file in the second cycle.

Another embodiment of the invention addresses a method of modifying portions of an operand for execution. A first operand partitioned into two or more portions is read from a register file. A second operand partitioned into two or more portions is generated from an execution unit. One portion of the two or more portions of the second operand is merged in place of one portion of the two or more portions of the first operand to create a merged operand. The merged operand is operated on to generate a merged result.

A more complete understanding of the present invention, as well as further features and advantages of the invention, will be apparent from the following Detailed Description and the accompanying drawings.

### BRIEF DESCRIPTION OF THE DRAWINGS

FIG. 1 is a block diagram of an exemplary wireless communication system in which an embodiment of the invention may be advantageously employed;

FIG. 2 is a functional block diagram of a processor complex which supports a read, merge, write (RMW) register file in accordance with the present invention;

FIG. 3A illustrates an exemplary read, merge, write (RMW) register file and data path in accordance with the present invention;

FIGS. 3B, 3C, and 3D illustrate the data paths followed in the RMW register file and data path of FIG. 3A in accordance with the present invention;

FIGS. 4A-4D are RMW register file state diagrams that show the state of various registers in a multiport storage unit in accordance with the present invention; and

FIG. 5 illustrates a process of read merge write.

### DETAILED DESCRIPTION

The present invention will now be described more fully with reference to the accompanying drawings, in which several embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

Computer program code or “program code” for being operated upon or for carrying out operations according to the teachings of the invention may be initially written in a high level programming language such as C, C++, JAVA®, Smalltalk, JavaScript®, Visual Basic®, TSQL, Perl, or in various other programming languages. A program written in one of these languages is compiled to a target processor architecture by converting the high level program code into a native assembler program. Programs for the target processor architecture may also be written directly in the native assembler language. A native assembler program uses instruction mnemonic representations of machine level binary instructions. Program code or computer readable medium as used herein refers to machine language code such as object code whose format is understandable by a processor.

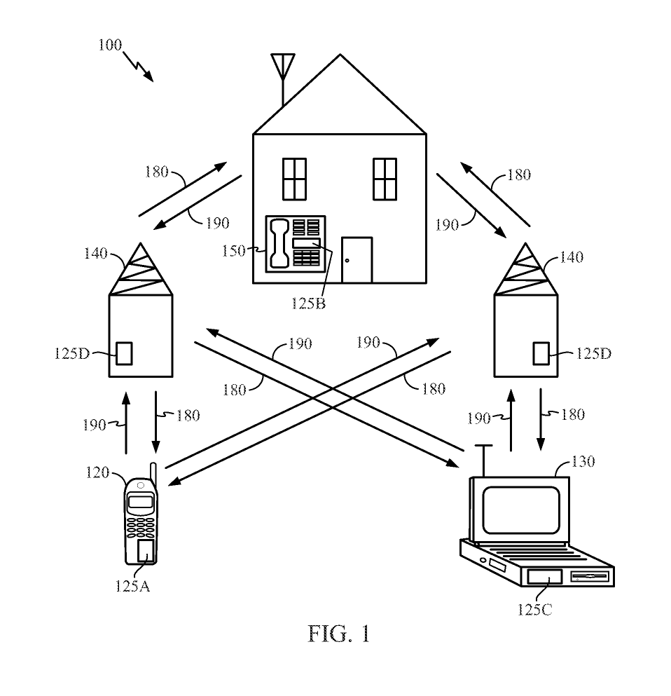

FIG. 1 illustrates an exemplary wireless communication system 100 in which an embodiment of the invention may be advantageously employed. For purposes of illustration, FIG. 1 shows three remote units 120, 130, and 150 and two base stations 140. It will be recognized that common wireless communication systems may have many more remote units and base stations. Remote units 120, 130, 150, and base stations 140 which include hardware components, software components, or both as represented by components 125A, 125C, 125B, and 125D, respectively, have been adapted to embody the invention as discussed further below. FIG. 1 shows forward link signals 180 from the base stations 140 to the remote units 120, 130, and 150 and reverse link signals 190 from the remote units 120, 130, and 150 to the base stations 140.

In FIG. 1, remote unit 120 is shown as a mobile telephone, remote unit 130 is shown as a portable computer, and remote unit 150 is shown as a fixed location remote unit in a wireless local loop system. By way of example, the remote units may alternatively be cell phones, pagers, walkie talkies, handheld personal communication system (PCS) units, portable data units such as personal digital assistants, or fixed location data units such as meter reading equipment. Although FIG. 1 illustrates remote units according to the teachings of the disclosure, the disclosure is not limited to these exemplary illustrated units. Embodiments of the invention may be suitably employed in any processor system having a register file and execution units supporting instructions having different data path requirements.

In multiple stage pipelines, an instruction waiting on a previous execution result is generally stalled, pending the completion of executing the previous instruction. Once the previous instruction has generated a result in an execution stage, the result of that execution may be written back to a register file, taking an additional pipeline stage before the result can be accessed by the stalled instruction. For example, in a program sequence of a load instruction followed immediately by an add instruction that uses the loaded value as a source operand for an addition, a processor pipeline would generally be stalled pending storing the load instruction value in a register file. With the processor pipeline having fetch, decode, dispatch, operand fetch, execute, and write-back stages and assuming there are no memory delays in fetching the load instruction value, the source operand for the add instruction would not be available until the end of the write-back stage for the load instruction. As a result, the add instruction would be stalled for two pipeline stage execution cycles.

In some processor pipelines, an execution result may be forwarded from the end of the execute stage to the operand fetch stage when that result is a completely specified data type input operand required for the execution of the add instruction. Completely specified in this context means having all data elements of an instruction specified data type available for execution, such as the result being a single 32-bit value for an instruction specified single 32-bit data type value or the result having four 32-bit values for an instruction specified quad 32-bit data type (128-bits total). For example, a pipeline may forward a single 32-bit data type value received at the end of executing a load instruction for use by a following add instruction which requires the single 32-bit data type value as one of the input operands. The add instruction begins execution using the single 32-bit data type value from the forwarding network as one of the source operands in parallel with loading the single 32-bit data type value to the register file to complete the execution of the load instruction. By forwarding the single 32-bit data type value as a source operand, the source operand would be available at the end of the load instruction execution stage and the add instruction would be stalled for one pipeline stage execution cycle.

Generally, programs operate on a single data type for a relatively large number of instructions, such that the effect of changing data types on a processor pipeline is minimized. As noted above, operands must be completely specified in order to forward the operand and satisfy the input operand requirements of the following instruction. However, present systems may not be able to determine when an operand is completely specified. Additionally, with the introduction of multimedia functions, a processor may use a large number of different data types to support those functions. There are a number of reasons for this including, for example, a requirement to maintain precision of calculations, use of multiplication operations (such that an 8-bit by 8-bit multiply produces a 16-bit result), extending precision requirements in accumulate operations, and increased parallelism. Thus, numerous application programs process data operands having different data types, such as eight bits, sixteen bits, thirty-two bits, sixty-four bits, and the like. In addition, single instruction multiple data (SIMD) instructions operate on a plurality of operands in parallel. For example, with a 128-bit data path, sixteen 8-bit operands, or eight 16-bit operands, or four 32-bit operands, or two 64-bit operands may be operated on in parallel. Such SIMD instructions are many times mixed with single instruction single data (SISD) instructions that specify a single value data type, such as an 8-bit operand, a 16-bit operand, or a 32-bit operand, for example. However, present processor pipelines generally assert stalls in order to deal with pipeline dependencies resulting from the execution of instructions that specify different data types.

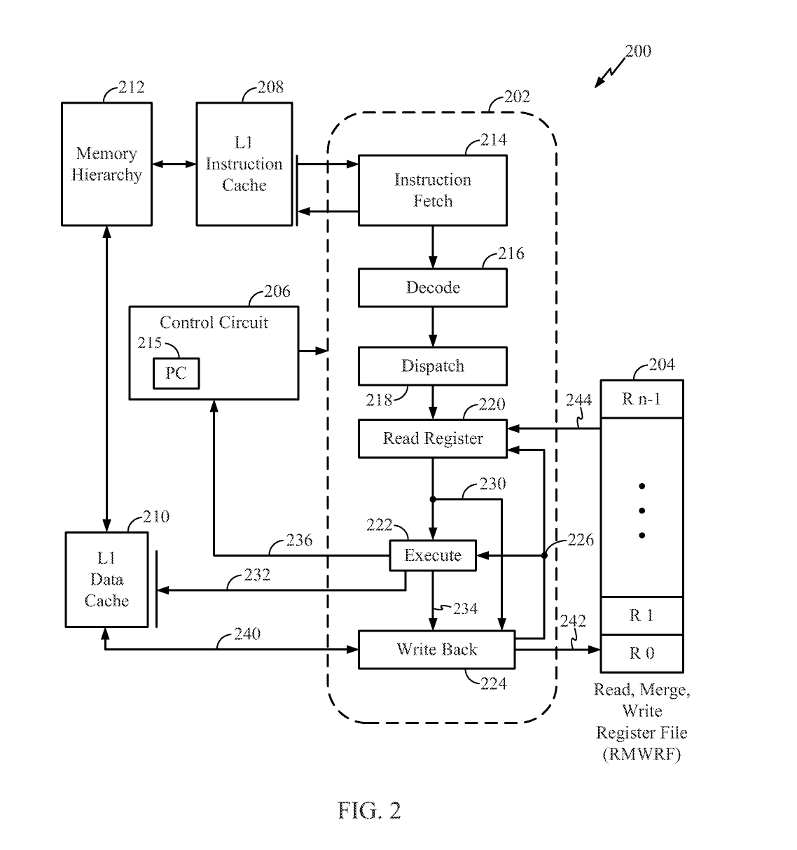

FIG. 2 is a functional block diagram of a processor complex 200 which supports a read, merge, write (RMW) register file in accordance with the present invention. The processor complex 200 includes processor pipeline 202, a RMW register file (RMWRF) 204, a control circuit 206, an L1 instruction cache 208, an L1 data cache 210, and a memory hierarchy 212. The control circuit 206 includes a program counter (PC) 215. Peripheral devices which may connect to the processor complex are not shown for clarity of discussion. The processor complex 200 may be suitably employed in hardware components 125A-125D of FIG. 1 for executing program code that is stored in the L1 instruction cache 208, utilizing data stored in the L1 data cache 210 and associated with the memory hierarchy 212. The processor pipeline 202 may be operative in a general purpose processor, a digital signal processor (DSP), an application specific processor (ASP) or the like. The various components of the processing complex 200 may be implemented using application specific integrated circuit (ASIC) technology, field programmable gate array (FPGA) technology, or other programmable logic, discrete gate or transistor logic, or any other available technology suitable for an intended application.

The processor pipeline 202 includes, for example, six major stages: an instruction fetch stage 214, a decode stage 216, a dispatch stage 218, a read register stage 220, an execute stage 222, and a write back stage 224. Though a single processor pipeline 202 is shown, the processing of instructions using the RMW register file of the present invention is applicable to superscalar designs and other architectures implementing parallel pipelines. For example, a superscalar processor designed for high clock rates may have two or more parallel pipelines and each pipeline may divide the instruction fetch stage 214, the decode stage 216, the dispatch stage 218, the read register stage 220, the execute stage 222, and the write back stage 224 into two or more pipelined stages increasing the overall processor pipeline depth in order to support a high clock rate.

Beginning with the first stage of the processor pipeline 202, the instruction fetch stage 214 associated with a program counter (PC) 215, fetches instructions from the L1 instruction cache 208 for processing by later stages. If an instruction fetch misses in the L1 instruction cache 208, meaning that the instruction to be fetched is not in the L1 instruction cache 208, the instruction is fetched from the memory hierarchy 212 which may include multiple levels of cache, such as a level 2 (L2) cache, and main memory. Instructions may be loaded to the memory hierarchy 212 from other sources, such as a boot read only memory (ROM), a hard drive, an optical disk, or from an external interface, such as a network. A fetched instruction is then decoded in the decode stage 216.

The dispatch stage 218 takes one or more decoded instructions and dispatches them to one or more instruction pipelines, such as utilized, for example, in a superscalar or a multi-threaded processor. The read register stage 220 fetches data operands from the RMWRF 204 or receives data operands from a forwarding network 226. The forwarding network 226 provides a fast path around the RMWRF 204 to supply result operands as soon as they are available from the execution stages as described in more detail below. Even with a forwarding network, result operands from a deep execution pipeline may take multiple execution cycles. During these cycles, an instruction in the read register stage 220 that depends on result operand data from the execution pipeline, must wait until the result operand is available. The execute stage 222 executes the dispatched instruction and the write-back stage 224 writes the result to the RMWRF 204 and may also send the results back to read register stage 220 through the forwarding network 226 if the result is to be used in a following instruction. Since results may be received in the write back stage 224 out of order compared to the program order, the write back stage 224 uses processor facilities to preserve the program order when writing results to the RMWRF 204. A more detailed description of the processor pipeline 202 using the RMW register file 204 is provided below with detailed code examples.

The processor complex 200 may be configured to execute instructions under control of a program stored on a computer readable storage medium. For example, a computer readable storage medium may be either directly associated locally with the processor complex 200, such as may be available from the L1 instruction cache 208, for operation on data obtained from the L1 data cache 210, and the memory hierarchy 212 or through, for example, an input/output interface (not shown). The processor complex 200 also accesses data from the L1 data cache 210 and the memory hierarchy 212 in the execution of a program.

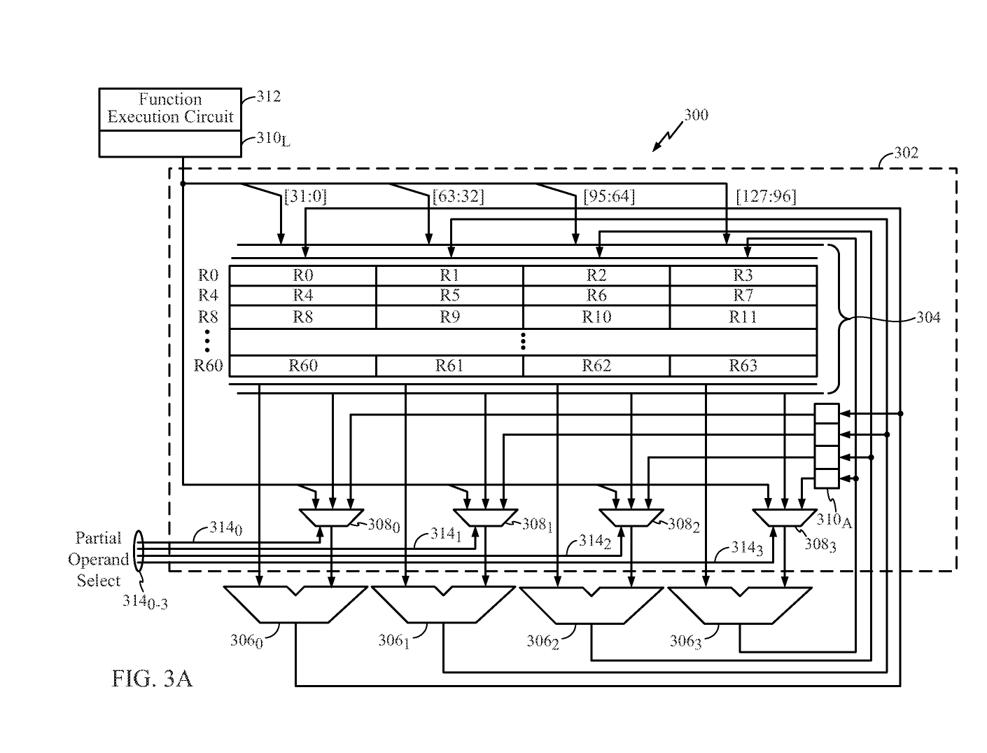

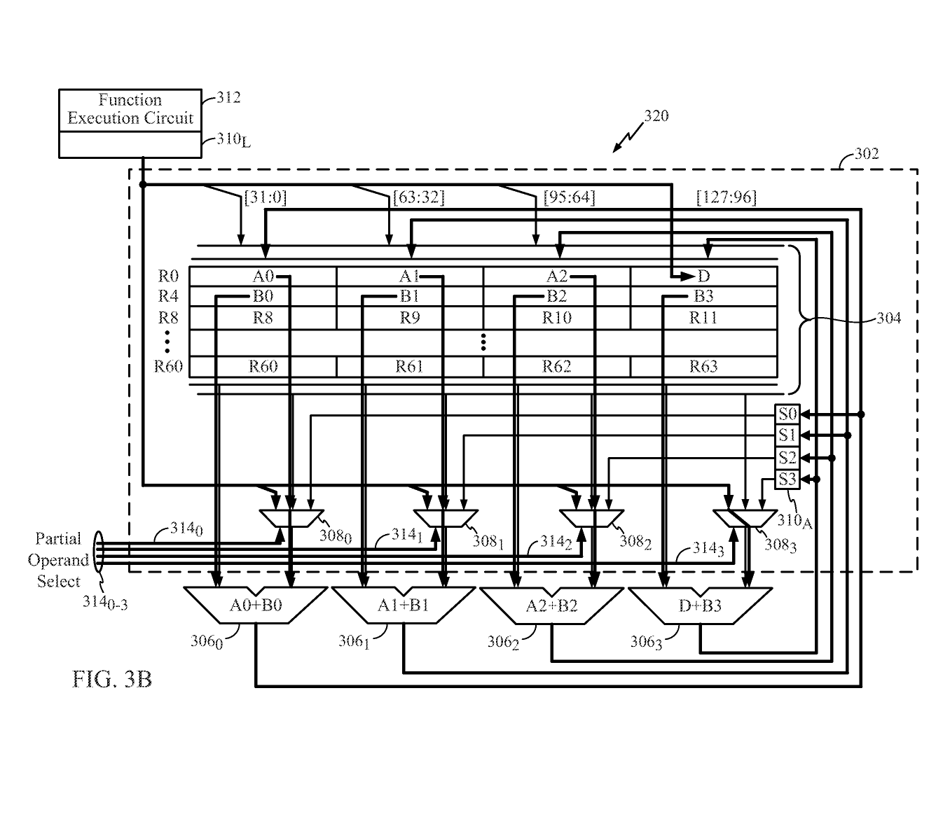

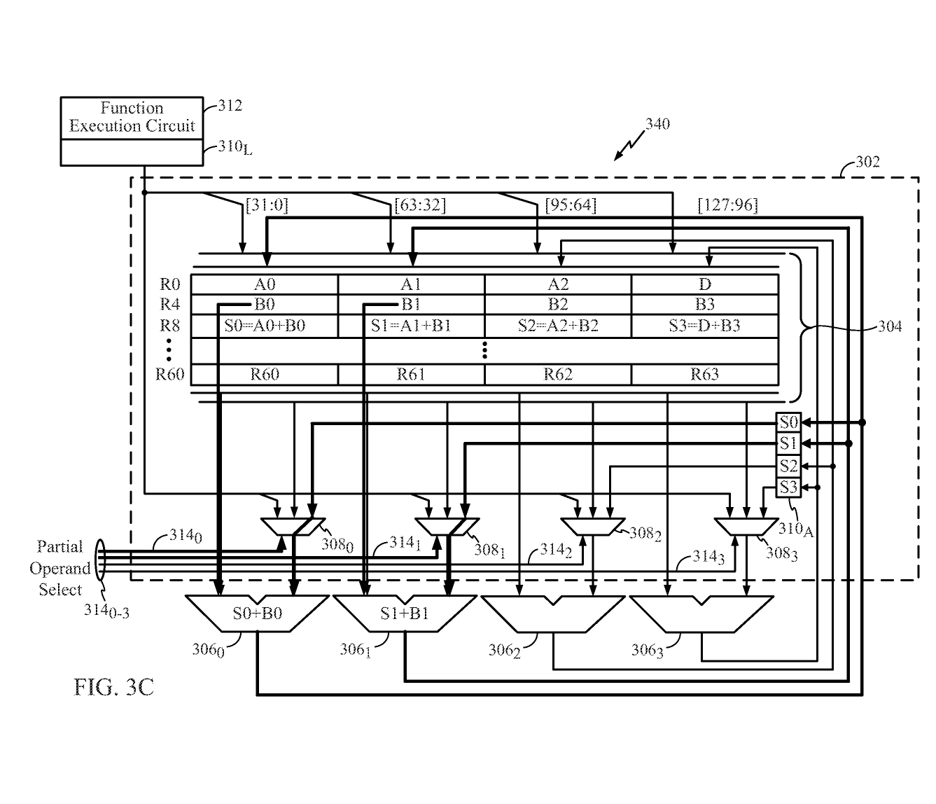

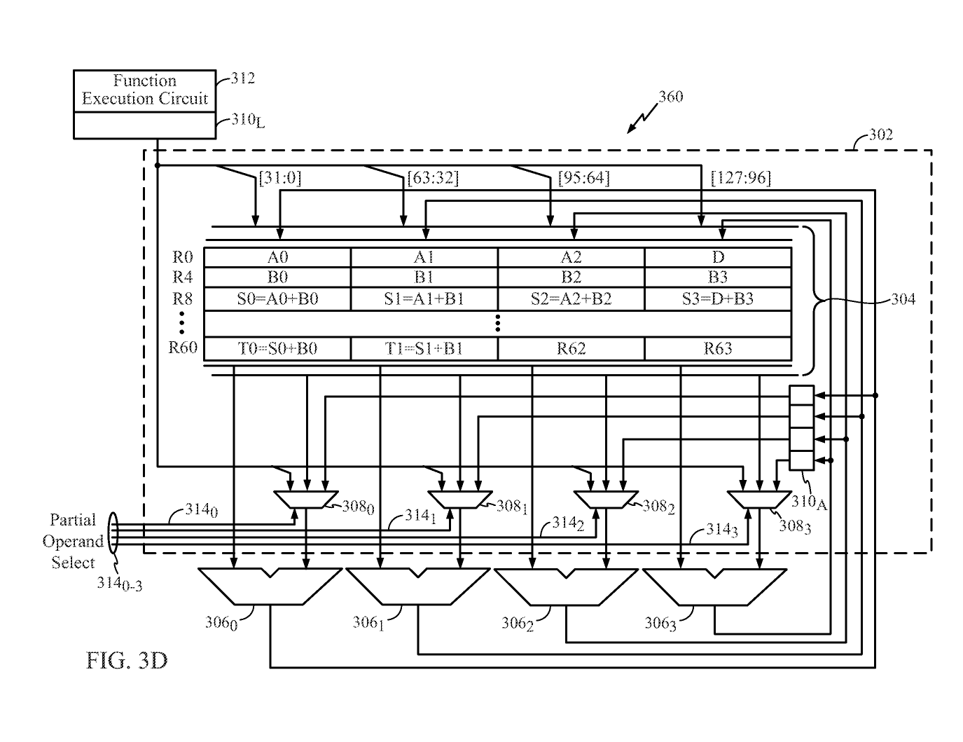

FIG. 3A illustrates an exemplary read, merge, write (RMW) register file and data path 300 in accordance with the present invention. The RMW register file and data path 300 include a read merge write register file (RMWRF) 302 having a multiport storage unit 304, partial operand multiplexers 308₀-308₃, and a partial operand storage unit 310. The RMWRF 300 also includes SIMD execution units 306₀-306₃ and a function execution circuit 312 that responds to other arithmetic or load instructions, for example. The multiport storage unit 304 stores, for example, sixty-four 32-bit data values in sixty-four registers that may be addressed to access four bytes packed in a 32-bit word, two halfwords packed in a 32-bit word, a 32-bit word, eight bytes packed in a 64-bit doubleword, four halfwords packed in a 64-bit doubleword, a 64-bit double word, sixteen bytes packed in a 128-bit quadword, eight halfwords packed in a 128-bit quadword, or a 128-bit quadword. The multiport storage unit 304 may include multiple read and write ports, of which two 128-bit read ports and two 128-bit write ports are shown. Four SIMD execution units 306₀-306₃ operate on a first operand having four 32-bit values obtained from a first 128-bit read port of the multiport storage unit 304 and a second operand having four 32-bit values obtained from the partial operand multiplexers 308₀-308₃. Partial operand select signals 314₀₋₃, having a select signal for each multiplexer, are individually controllable to select the appropriate path through the multiplexers. The inputs to the partial operand multiplexers 308₀-308₃ are from a second 128-bit read port of the multiport storage unit 304, from the function execution circuit 312 (such as a quad halfword multiplier that produces four 32-bit results or a load execution circuit that responds to load instructions), and from the partial operand storage unit 310.

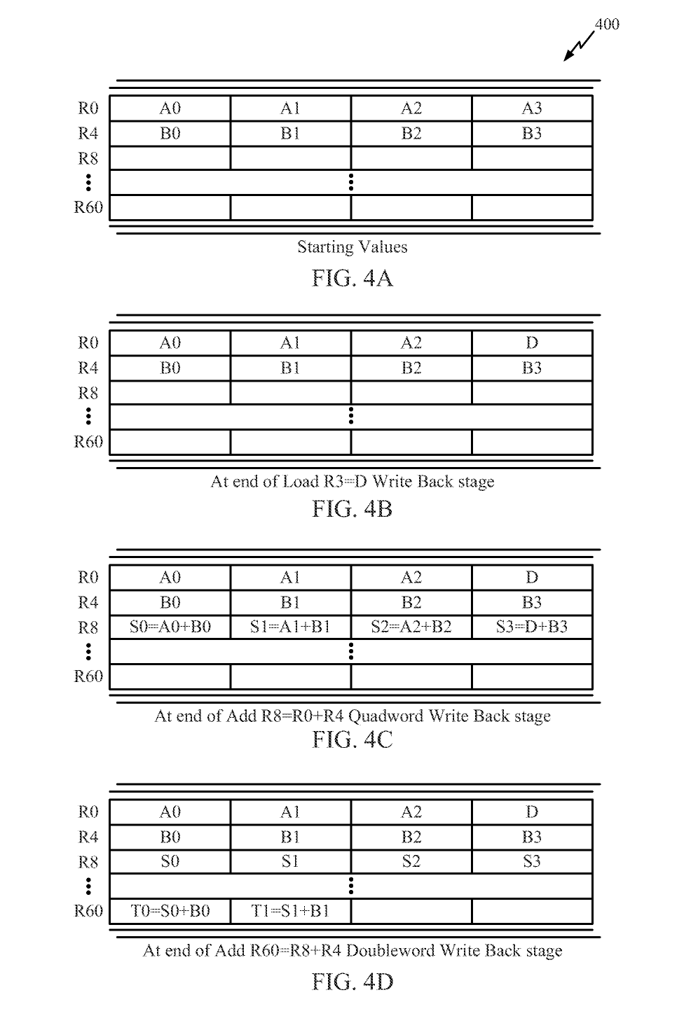

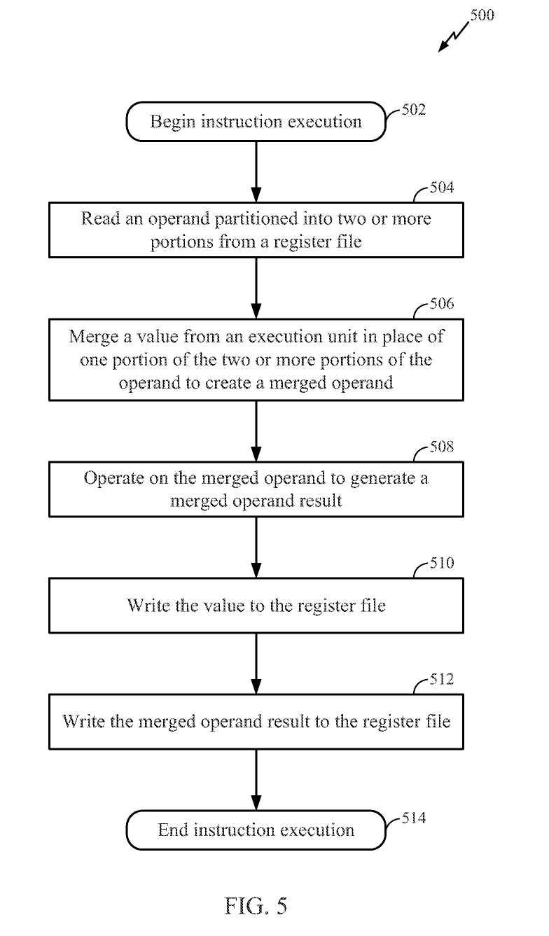

FIGS. 4A-4D are RMW register file state diagrams 400 that show examples of the state of various registers in the multiport storage unit 304 in accordance with the present invention. The data paths followed in the RMW register file and data path 300 of FIG. 3A are shown in FIGS. 3B, 3C, and 3D. FIG. 3B shows the data paths followed in a second cycle that results in the state shown in FIG. 4B. FIG. 3C shows the data paths followed in a third cycle that results in the state shown in FIG. 4C. FIG. 3D shows the data paths followed in a fourth cycle that results in the state shown in FIG. 4D. The operation of the RMW register file and data path 300 of FIG. 3A are described using the RMW register file state diagrams 400 for the execution of a simple program [1] having pseudocode instructions, shown below. Program [1] uses three different data types beginning with a word data type in instruction {001} that loads a 32-bit value, a quadword data type in instruction {002} that adds two 128-bit packed operands, each 128-bit packed operand having four 32-bit values, and a doubleword data type in instruction {003} that adds two 64-bit packed operands, each 64-bit packed operand having two 32-bit values. For purposes of the execution of program [1], the function execution circuit 312 is a load execution unit and the SIMD execution units 306₀-306₃ are SIMD add execution units.

{001} Load Reg3←D, word;

{002} Add Reg8←Reg0+Reg 4, Quadword;

{003} Add Reg60←Reg8+Reg4, Doubleword; Program [1]

In program [1], a load execution unit, responding to the load instruction {001}, fetches a value from memory to be loaded into the read merge write register file by the end of an execute cycle. An add execution unit, responding to the add instruction {002}, adds two quad word operands, one beginning with register 0 (Reg0) and one beginning with register 4 (Reg4). The Reg0 quad word operand is partitioned into four register portions Reg0-Reg3. The Reg3 portion of the Reg0 quad word operand poses a data dependency on the value fetched in response to the load instruction {001}. In accordance with the present invention, the Reg3 value from the load execution unit is merged in place of the Reg3 (R3) portion of the Reg0 (R0) quad word to create a merged operand that includes register values R0, R1, and R2, and the value. Due to the dependency on register 3 (R3) from the load instruction {001}, the register R3 may not be read from the register file, since it is not used in the merge operation. The suppression of reading R3 depends upon the capabilities of the register file. For example, the add instruction {002} specifies a read R0 quadword operand which includes R0, R1, R2, and R3 and the multiport storage unit 304 also supports reading of single 32-bit registers, as described above with regard to FIG. 3A. Thus, the read of R3 may be suppressed, since the R3 value is obtained from the load execution unit and merged in place of the R3 portion of the Reg0 quad word. Suppression of read operations for portions of operands to be merged, efficiently resolves data dependencies and reduces power use. Continuing with program [1], the add execution unit, responding to the add instruction {002}, operates on the merged operand. While the merged operand is being operated on, the value fetched in response to the load instruction {001} is written to the register file.

In a similar manner, the add execution unit, responding to the add instruction {003}, adds two double word operands, one beginning with register 8 (Reg8) and one beginning with register 4 (Reg4). The Reg8 double word operand is partitioned into two register portions Reg8 and Reg9. The Reg8 double word operand poses a data dependency on the merged operand Reg8 quad word generated in response to the add instruction {002}. In accordance with the present invention, the Reg8 double word, a portion of the add execution unit result responding to add instruction {002}, is selected for addition with the Reg4 double word. The add execution unit, responding to the add instruction {003}, then operates on the double word operands. While the double word operands are being operated on, the result generated in response to the add instruction {002} is written to the register file.

FIG. 4A shows 32-bit values A0, A1, A2, and A3 in registers R0, R1, R2, and R3, respectively, and 32-bit values B0, B1, B2, and B3 in registers R4, R5, R6, and R7, respectively, before executing the load instruction {001}. At the end of the execute stage for the load instruction, a first cycle, the value D is stored in storage unit 310_{L}, such as a pipeline stage register. Thus, as shown in FIG. 3B, the value D is available to be applied to multiplexer 308₃ and selected by one of the partial operand select signals 314₃ to pass the value D to the SIMD execution unit 306₃. Also at the end of the execute stage for the load instruction, which is the start of the execution stage for the add instruction {002}, the multiport storage unit 304 provides the values A0, A1, and A2 to the multiplexers 308₀-308₂ which are selected by the associated partial operand select signals 314₀₋₂ to pass the values A0, A1, and A2 to the SIMD execution units 306₀-306₂, respectively. Since D is obtained from the storage unit 310_{L} through multiplexer 308₃, the reading of R3 from the multiport storage unit 304 is suppressed. The 32-bit values B0, B1, B2, and B3 are provided to the SIMD execution units 306₀-306₃, respectively, as the second operand.

The addition specified by the add instruction {002} occurs in parallel with the write-back of the value D to register R3 of the multiport storage unit 304 in a second cycle. FIGS. 3B and 4B show the state of the multiport storage unit 304 at the end of the load R3=D write back stage. At the end of the execute stage for the add instruction {002}, the end of the second cycle, the values S0=A0+B0, S1=A1+B1, S2=A2+B2, and S3=D+B3 are loaded into the partial operand storage unit 310_{A}.

At the end of the execute stage for the add instruction {002}, which is the start of the execution stage for the add instruction {003}, the multiport storage unit 304 provides the values B0 and B1 to the SIMD execution units 306₀ and 306₁ as a first packed operand of the add instruction {003} as shown in FIG. 3C. The partial operand outputs of the partial operand storage unit 310_{A} are applied to multiplexers 308₀-308₃. The associated partial operand select signals 314₀, selects multiplexers 308₀ and 308, to pass the values S0 and S1 to the SIMD execution units 306₀ and 306₁, respectively as the second packed operand of the add instruction {003}. The SIMD execution units 306₂ and 306₃ are not used in the execution of the add instruction {003}.

The addition specified by the add instruction {003} occurs in parallel with the write-back of the values S0-S3 to registers R8-R11, respectively, of the multiport storage unit 304 in a third cycle. FIGS. 3C and 4C show the state of the multiport storage unit 304 at the end of the add instruction {002} write back stage. FIGS. 3D and 4D show the state of the multiport storage unit 304 at the end of the add instruction {003} write back stage, a fourth cycle.

FIG. 5 illustrates a process 500 of read merge write. At block 502, an execution of an instruction begins. For example, the add instruction {002} is started. The add instruction {002} specifies a quad word add operation on an operand partitioned into four words A0, A1, A2, and A3 and a second operand partitioned into four words B0, B1, B2, and B3 as shown in FIG. 4A. At block 504, the operand having A0, A1, A2, and A3 and the second operand having B0, B1, B2, and B3 are read from a register file, such as the multiport storage unit 304 of FIG. 3B. Also, at block 504, due to the dependency on register 3 (R3) from the load instruction {001}, the register R3 may not be read from the register file since it is not used by the merge operation. At block 506, a value D from the function execution circuit 312 is merged in place of the register R3 output using multiplexer 308₃ and selected by 314₃. Thus, the read of R3 may be suppressed for the execution of the add instruction {002}, since the R3 value is obtained from the load execution unit and merged in place of the R3 portion of the Reg0 quad word. A merged operand is created at the outputs of multiplexers 308₀-308₃. At block 508, the merged operand is operated on to generate a merged operand result. For example, the merged operand A0, A1, A2, and D is added to the operand B0, B1, B2, and B3, respectively, in the SIMD execution units 306₀-306₃ as shown in FIG. 3B. At block 510, the value D is written to the register file, as shown in FIG. 3B. At block 512, the merged operand result is written to the register file, as shown in FIG. 3C. At block 514, the execution of the instruction ends. For example, the add instruction {002} is ended having completed its specified function.

The methods described in connection with the embodiments disclosed herein may be embodied in a combination of hardware and in a software module storing non-transitory signals executed by a processor. The software module may reside in random access memory (RAM), flash memory, read only memory (ROM), electrically programmable read only memory (EPROM), hard disk, a removable disk, tape, compact disk read only memory (CD-ROM), or any other form of storage medium known in the art. A storage medium may be coupled to the processor such that the processor can read information from, and in some cases write information to, the storage medium. The storage medium coupling to the processor may be a direct coupling integral to a circuit implementation or may utilize one or more interfaces, supporting direct accesses or data streaming using downloading techniques.

While the invention is disclosed in the context of illustrative embodiments for use in processors it will be recognized that a wide variety of implementations may be employed by persons of ordinary skill in the art consistent with the above discussion and the claims which follow below. For example, while FIG. 3 illustrates read merge write elements, such as the partial operand multiplexers 308₀-308₃ and the storage unit 310, operating on a single operand port from the multiport storage unit 304, it is appreciated that such read merge write elements may be implemented on each operand port associated with various SIMD execution units, such as the SIMD execution units 306₀-306₃ and the function execution circuit 312. It is also appreciated that the merging function may be performed with one set of forwarding logic, or multiple sets of forwarding logic that are shared with the operand read path or separately controlled. For example, for a three input operand instruction, two value-forwarding paths could be implemented and each of the three input operands may use any one of the two forwarding paths. It is further appreciated that the partial operand storage unit 310 of FIG. 3 may be a buffer that holds one or more values.

What is claimed is:

1. A method of read, merge, and write, the method comprising:
reading an operand partitioned into two or more portions from a register file;
merging a value from an execution unit in place of one portion of the two or more portions of the operand to create a merged operand;
operating on the merged operand to generate a merged operand result; and
writing the value to the register file.

2. The method of claim 1, wherein each portion of the two or more portions is a multiple of a data granularity, the data granularity having a specified number of bits, the value having one or more portions, and the value smaller in width than the operand.

3. The method of claim 2, wherein the data granularity is 8-bits, each portion is 16-bits, the operand is 32-bits, and the value is 16-bits.

4. The method of claim 2, wherein the data granularity is 8-bits, each portion is 8-bits, the operand is 128-bits, and the value is 8-bits.

5. The method of claim 1, wherein the operand consists of multiple data elements which are operated upon in a single instruction multiple data (SIMD) fashion.

6. The method of claim 1, wherein the one portion of the operand that is replaced by the value is not read from the register file.

7. The method of claim 1, further comprising:
merging a first subset of values from a plurality of execution units in place of a subset of portions of the operand to create a merged operand.

8. The method of claim 1, wherein the operand is accessed from a storage unit.

9. The method of claim 1, wherein the value from an execution unit is a portion of a result generated by the execution unit.

10. The method of claim 1, further comprises:
writing the merged operand result to the register file.

11. The method of claim 1, wherein a plurality of execution units each operate on a different portion of the merged operand.

12. The method of claim 1, wherein the execution unit is configured to provide load operations.

13. The method of claim 1, wherein the execution unit is configured to provide arithmetic or logical operations.

14. The method of claim 1, further comprising:
reading from a register file a second operand partitioned into two or more portions;
merging a second value from a second execution unit in place of one portion of the two or more portions of the second operand to create a second merged operand;
operating on the merged operand and the second merged operand to generate a second merged operand result; and
writing the second value to the register file.

15. The method of claim 1, further comprising:
merging a second value from the execution unit in place of a second portion of the two or more portions of the operand to create a second merged operand;
operating on the merged operand and the second merged operand to generate a second merged operand result; and
writing the second value to the register file.

16. The method of claim 15, wherein the merged operand and the second merged operand are separate operand inputs to an execution unit that generates the second merged operand result.

17. The method of claim 15, wherein the merged operand is combined with the second merged operand as a single operand input to an execution unit that generates the second merged operand result.

18. An apparatus comprising:
a register file comprising a port for reading an operand partitioned into two or more portions;
first execution logic configured to generate a value in a first cycle;
multiplexing logic configured to merge the value in place of at least one portion of the two or more portions of the operand to create a merged operand;
second execution logic configured to perform an operation on the merged operand to generate a merged operand result in a second cycle; and
write back logic configured to write the value to the register file in the second cycle.

19. The apparatus of claim 18, wherein the merged operand result is written to the register file in a third cycle.

20. The apparatus of claim 18, further comprising:
a storage unit for supplying the value generated from the first execution logic and stored in the storage unit at the end of the first cycle.

21. The apparatus of claim 18, wherein the write back logic operates to write the value to the register file in a third cycle based on pipeline staging.

22. The apparatus of claim 21, wherein the register file further comprises a second port to read a second operand partitioned into two or more portions, third execution logic configured to generate a second value in the first cycle, the multiplexing logic configured to merge the second value in place of one portion of the two or more portions of the second operand to create a second merged operand, the second execution logic configured to operate on the merged operand and the second merged operand to generate a second merged operand result in the second cycle, and the write back logic operates to write the second value to the register file in the third cycle.

23. A method of modifying portions of an operand for execution, the method comprising:
reading a first operand partitioned into two or more portions from a register file;
generating a second operand partitioned into two or more portions from an execution unit;
merging one portion of the two or more portions of the second operand in place of one portion of the two or more portions of the first operand to create a merged operand; and
operating on the merged operand to generate a merged result.

24. The method of claim 23, wherein the first operand, the second operand, the merged operand, and the merged result are single instruction multiple data (SIMD) data types.
